(19) United States
(12) Patent Application Publication
(10) Pub. No.: US 2023/0376530 A1
(43) Pub. Date: Nov. 23, 2023

(54) CONTENT PLAYBACK SYSTEM

(71) Applicant: B & W Group Ltd, Worthing, West Sussex (GB)

(72) Inventor: Stephen Robbins, Worthing, West Sussex (GB)

(21) Appl. No.: 18/247,915

(22) PCT Filed: Oct. 27, 2021
(86) PCT No.: PCT/EP2021/079806

§ 371 Date: Apr. 5, 2023

(30) Foreign Application Priority Data
Oct. 28, 2020 (GB) 2017105.4

(51) Int. Cl. G06F 16/638; G06F 16/683; G06F 16/68; G06F 16/78

(52) U.S. Cl. CPC G06F 16/639; G06F 16/683; G06F 16/686; G06F 16/7867

(57) ABSTRACT

A content playback system is described having a local media store configured to store a plurality of media files and a playback unit configured to play the stored media files. The system further has a metadata extraction unit configured to extract metadata for each of the plurality of media files stored in the local media store, and a remote server. The remote server is configured to receive the extracted metadata from the metadata extraction unit and, based on the extracted metadata and a media database available to the remote server, generate a user database including identification information of media items contained in the plurality of media files stored in the local media store. The system is further configured to provide a user interface for interacting with the user database. This may enable a user to browse content stored in the local media store via the generated user interface.

### FIELD OF THE INVENTION

The present invention relates to a content playback system including a local media store for storing a plurality of media files, and a playback unit configured to play media files stored in the local media store. The invention further relates to a method of controlling a content playback system.

### BACKGROUND TO THE INVENTION

A home media library may typically include a large collection of media files that are stored in a local media store or storage device. Media files may correspond to a range of different types of digital media, such as audio (e.g. music), video (e.g. movies) and pictures. The media files may be played by a playback unit that is connected to the local media store. For example, in the case of an audio library, the playback unit may be an audio system that is arranged to play audio files stored in the local media store.

Different types of local media store may be used. For example, the local media store may be an external hard drive that is connected to the audio system via a connection port on the audio system, or wirelessly. In other cases, the local media store may be storage that is internal to the audio system, and onto which audio files can be loaded.

To control playback by the audio system, a user may typically use an interface provided on the audio system (or on a remote control), usually in the form of one or more buttons and a small display.

### SUMMARY OF THE INVENTION

At its most general, the present invention provides a content playback system having a local media store for storing a plurality of media files, and a playback unit for playing media files stored in the local media store. Metadata is extracted from media files stored in the local media store and is then transmitted to a remote server, where it is used to construct a user database corresponding to the plurality of media files stored in the local media store. The content playback system (e.g. the remote server) then provides a user interface, or a data service to support a user interface, which can be used to interact with the user database, e.g. it may enable a user to browse and/or organise the user database and select items or playlists for playback by the playback unit.

In this manner, a user may effectively browse content stored in the local media store via the generated user interface. This may be particularly beneficial, for example, where the playback unit and/or local media store do not include a user interface, or include only a limited user interface, such that it may be difficult for a user to browse and organise content directly on the local media store or on the playback unit. Thus, the system of the invention may enable a user to browse a user database corresponding to content on the local media store without having to directly physically interact with the local media store or the playback unit. This may enable a user to easily find desired content.

The system of the invention may also serve to reduce an amount of processing that is done locally, as the only processing done locally may be the extraction of metadata from the media files stored the local media store. Then, once the user database is constructed at the remote server, any further processing may be performed by the remote server on the user database. For example, various algorithms may be applied by the remote server to the user database, e.g. in order to organise items in the user database into categories and/or playlists, or recommend items from the user database to the user. For example, the remote server may dynamically recommend items in the user database to the user, e.g. based on current trends or other information that is available to the remote server. In this manner, processing of the user database (e.g. to make recommendations, generate playlists, etc.) may be performed at the remote server, without having to perform any further processing of the media files stored in the local media store.

Thus, the invention may enable a user to benefit from remote or cloud technologies (e.g. in terms of content browsing, recommendations, playlist generation), whilst still using content on their local media store. This may be particularly beneficial where the media files on the local media store are high-resolution/high-definition (e.g. high-resolution audio files). In such a case, the user may prefer to use the high-resolution media files rather than content streaming, as streaming may provide a lower resolution.

According to a first aspect of the invention, there is provided a content playback system comprising: a local media store configured to store a plurality of media files; a playback unit configured to play media files stored in the local media store; a metadata extraction unit configured to extract metadata for each of the plurality of media files stored in the local media store; and a remote server configured to: receive the extracted metadata from the metadata extraction unit; and based on the extracted metadata and a media database available to the remote server, generate a user database including identification information of media items contained in the plurality of media files stored in the local media store; wherein the content playback system is configured to provide a user interface for interacting with the user database.

The local media store may be any suitable storage device capable of storing a plurality of media files, for example any device including suitable computer memory for storing the plurality of media files.

Any suitable media file format may be used for the media files.

In some cases, the local media store may include multiple local storage devices.

The plurality of media files may correspond to all or a subset of all of the media files stored in the local media store. Thus, in some embodiments, metadata may be extracted for only a subset of the media files stored in the local media store. For example, in some cases, a user may select media files on the local media store for which metadata is to be extracted.

In one embodiment, the media files may be audio files. For example, each audio file may correspond to an audio track (or song). An audio file may, for example, have an MP3, AAC, WMA or any other suitable type of audio file format. In some cases, the audio files may be high-resolution or losslesss audio files such as WAV or FLAC.

In some cases, other types of media files may be used. For example, the media files stored in the local media store may be video files.

The playback unit is configured to play media files stored in the local media store. The playback unit may include a controller configured to access and read the media files stored in the local media store, the controller being adapted to the specific media file format used.

The local media store may be locally connected to the playback unit, so that the playback unit may access and play media files stored in the local media store. For example, the local media store may be connected to the playback unit via a wired (e.g. USB, Ethernet) or wireless (e.g. Bluetooth, WiFi) connection.

In some cases, the local media store may be incorporated into the playback unit. For example, the local media store may be in the form of an internal storage of the playback unit. The playback unit and local media store may therefore be parts of the same single device or apparatus.

The playback unit may be adapted to play the media files stored in the local media store. For example, where the media files are audio files, the playback unit may include an audio device, for example one or more speakers; where the media files are video files, the playback unit may include a display device (e.g. screen).

In some cases, the playback unit may be provided as a standalone device, e.g. as a separate playback device. In other cases, the playback unit may form part of another device, for example a user device (e.g. smartphone, tablet computer, laptop computer, personal computer or similar).

Each media file may contain (or store) a media item and corresponding metadata. Herein, a “media item” may refer to a piece of content, such as an audio track, song or video. For example, where the media file is an audio file, the audio file may contain an audio track and corresponding metadata.

The metadata may include identification information for identifying the media item contained in the media file. The metadata may serve to uniquely identify the media item contained in the media file. For example, where the media file is an audio file, the metadata may include one or more of a track (or song) name, an artist name and an album name.

Of course, the metadata may alternatively, or additionally, include other information about the media item.

The metadata extraction unit serves to extract metadata for the plurality of media files stored in the local media store. Metadata may be extracted for a media file by reading the media file to extract metadata contained in the media file. For example, the metadata extraction unit may be configured to read each of the plurality of media files stored in the local media store and extract the metadata contained in each of the media files. Thus, the extracted metadata may include metadata that was contained in the plurality of media files (e.g. track name, artist name, album name, etc.). The extracted metadata for each media file may further include an indication of a name of the media file.

The metadata extraction unit may be locally connected to the local media store, e.g. via a wired (e.g. USB, Ethernet) or wireless (e.g. Bluetooth, WiFi) connection, to enable the metadata extraction unit to read media files stored in the local media store. The connection between the metadata extraction unit and the local media store may be over a local network.

In some cases, the metadata extraction unit may be provided as a separate device that is in communication with the local media store. Alternatively, the metadata extraction unit may be incorporated into the playback unit or the local media store. For example, the metadata extraction unit may be implemented by software that is installed on the playback unit or the local media store. In other cases, the metadata extraction unit may be implemented by software that is installed on a user device (e.g. smartphone, tablet computer, laptop computer, personal computer or similar), which is in local communication with the local media store and/or the playback unit.

The metadata extraction unit may be configured to receive an indication of a location of the local media store. The metadata extraction unit may further be configured to, in response to receiving the indication of the location of the local media store, perform the extraction of metadata for the plurality of media files. Thus, extraction of metadata by the metadata extraction unit may be initiated by the user providing an indication to the content playback system (e.g. via an application on a user device) of a location of the local media store. For example, the user may provide an address of the local media store to the content playback system, or select the local media store from a list of available storage devices.

After extracting the metadata for the plurality of files stored in the local media store, the metadata extraction unit may then transmit the extracted metadata to the remote server. The extracted metadata may be transmitted to the remote server over a non-local network, e.g. over the internet. Extracting metadata locally from the media files on the local media store may avoid having to transmit the media files themselves to the remote server. This may reduce bandwidth usage, as only the metadata need be transmitted to the remote server. This may also reduce burden on the remote server, as the remote server need not receive and store large volumes of media files.

The remote server may be any suitable server or computer that is connected to the internet. For example, the remote server may be a cloud server. When the remote server receives the extracted metadata from the metadata extraction unit, it may then generate a user database based on the extracted metadata and an existing media database.

The media database is available to the remote server, i.e. it may be accessed by the remote server. The media database may be stored in the remote server. Alternatively the media database may be stored in a separate database server that is accessible by the remote server (e.g. via the internet). The media database may also be referred to as a global catalog.

The media database may include identification information for a set of media items, e.g. the media database may include a list of media items. As an example, where the remote server (and the database server, if present) are part of an online music service, the media database may include an exhaustive list of media items that are known to, or available via, the online music service. The media database may include identification information such as the names and artists of the media items in the media database. Where the media files are audio files, the media database may include identification information for audio tracks (or songs), e.g. including track names and artist names for the audio tracks.

The remote server is configured to generate the user database by identifying media items in the media database based on the extracted metadata. The identification information in the extracted metadata (e.g. track name, artist name) may be used to identify media items from the media database which correspond to the media files stored in the local media store, e.g. by comparing identification information in the extracted metadata with identification information of the media items in the media database.

For example, the user database may include a list of media items identified from the media database based on the extracted metadata.

The user database may also be referred to as a user catalog.

The remote server may be configured to, for each of the plurality of media files stored in the local media store, identify a media item from the media database, based on the metadata extracted for that media file. This may be achieved, for example, by performing a search on the media database to identify a media item corresponding to metadata extracted for the media file. For example, where the metadata extracted for a media file includes a track name and an artist name, the remote server may search the media database for an audio track having matching or near matching track name, artist name and other metadata.

Thus, the media items identified in the user database may correspond to the plurality of media files stored in the local media store. In other words, there may be a one-to-one correspondence between the media files stored in the local media store and the media items in the user database. The user database may include a plurality of entries having media item identification information, each of the plurality of entries corresponding to a media file stored on the local media store.

Herein, a media item identified in the user database may refer to a media item for which the user database includes identification information. Similarly, a media item identified in the media database may refer to a media item for which the media database includes identification information.

Identification information may be information identifying (e.g. uniquely identifying) the media item, such as one or more of artist name, track name, album name, reference number, duration, genre, track number, etc.

The user database may include the extracted metadata received from the metadata extraction unit.

The user database may include a user identifier, e.g. a user identifier associated with a user profile stored on the remote server.

The user database may include a database identifier for identifying the user database.

The user database may associate each media item identified in the user database with a corresponding media file stored in the local media store. In this manner, the user database may be used to identify media files stored in the local media store. For example, for each media item identified in the user database, the user database may indicate a name of the corresponding media file, or some other identifying information of the corresponding media file.

Where the media files are audio files, the user database may include identification information for a plurality of audio tracks that are contained in the plurality of audio files stored in the local media store. The identification information for the audio tracks may, for example, include the track names and artist names for the audio tracks. The user database may associate each audio track in the list of audio tracks with the corresponding audio file stored in the local media store.

After generating the user database, the content playback system is configured to provide (e.g. generate) a user interface for interacting with the user database. Interacting with the user database may, for example, include browsing the user database, selecting one or more items in the user database, selecting one or more playlists of the user database, searching the user database (e.g. by inputting one or more search terms), organising the user database (e.g. organising the media items into one or more categories), or other types of interaction with the user database.

The user interface may thus enable the user to browse a user database corresponding to the plurality of media files stored in the local media store, without directly interacting with the local media store or the playback unit.

The user interface may be tailored to a user's preferences. For example, the user interface may be generated based on user preferences, e.g. to provide a more intuitive and easy-to-use interface for the user. The user interface is not limited to the particular playback unit used.

In some cases, the remote server may be configured to generate the user interface. The user interface may be configured to be presented by a user device (e.g. mobile device) that is in communication with the remote server. For example, the user interface may be presented via an application installed on the user device. In this manner, a user may interact with the user database via the user interface presented on the user device.

In other cases, the content playback system may include a user device (e.g. mobile device) that is configured to generate the user interface. In such a case, the remote server may be in communication with the device and configured to transmit the user database to the user device, so that the user device may generate the user interface. The user interface may be generated, using the received user database, by software (e.g. an App) that is installed on the user device. The user device may, for example, be a smartphone, tablet computer, laptop computer or similar. The remote server may be in communication with the user device over a non-local network, e.g. over the internet.

The user device may be separate to the playback unit. For example, the playback unit may be a device comprising a speaker, and the user device may be a separate device such as a smartphone, tablet computer, laptop computer, personal computer or similar.

Alternatively the user device and the playback unit may be part of the same device. For example, the user device and playback device may both be provided by a single smartphone, tablet computer, laptop computer, personal computer or similar.

Where the user device is separate to the playback unit, the user device may be configured to communicate with the cloud and not to communicate directly with the playback unit.

In some embodiments, the metadata extracted for each media file in the local media store may include an indication of a storage location in the local media store of that media file; and the user database may associate each media item identified in the user database with an indication of the storage location in the local media store for a corresponding media file stored in the local media store that contains that media item. In this manner, the remote server may keep a record of where the media file containing each media item identified in the user database is stored. For example, the storage location for a media file may include an address of the media file in the local media store. Additionally or alternatively, the storage location for a media file may include a network-addressable location for the media file (e.g. corresponding to a network address for the local media store). This may facilitate locating a desired media file in the local media store, e.g. for playback of the media file.

The user database may include data about the storage device, e.g. name of storage device, type of storage device, size of storage device, location of storage device, etc.

The user interface may be configured to receive an input from a user and, based on the input from the user, the remote server may be configured to transmit an instruction to the playback unit to play one or more media files stored in the local media store. In this manner, the user may interact with the user interface generated by the remote server, in order to control playback by the playback unit of media files stored in local media store. This may facilitate control of playback of media files stored in the local media store, as the user can control playback directly via the user interface, without having to interact with the playback unit and/or local media store. This may also enable rapid and responsive control of playback. This is because the media files are already stored locally on the local media store, such that there is no need to download or stream content from the Internet for playback. This may avoid buffering issues and/or drops in quality due to fluctuations in bandwidth.

The playback unit may be configured to, in response to receiving the instruction from the remote server, play the one or more media files. This may involve the controller in the playback unit accessing the one or more media files on the local media store, and playing the one or more media files (e.g. via a speaker on the playback unit).

Where the user interface is configured to be presented on a user device, receiving the input from the user may include transmitting an indication of the user input from the user device to the remote server. Similarly, where the user interface is configured to be presented on the playback unit, receiving the input from the user may include transmitting an indication of the user input from the playback unit to the remote server.

The playback unit may be configured to receive instructions from the remote server. For example, the playback unit may be a network-enabled playback unit which is connected to the internet, so that it may receive instructions from the remote server. When the playback unit receives an instruction from the remote server, the playback unit may be configured to access the one or more media files stored in the local media store that are indicated in the instruction, and play the one or more media files.

Where the user database associates each media item identified in the user database with an indication of the storage location on the local media store for the corresponding media file stored in the local media store, the instruction to the playback unit may include an indication of the storage location in the local media store of the one or more media files to be played. In this manner, the playback unit may access the one or more media files at the storage locations indicated in the instruction from the remote server. This may avoid the playback unit having to search the local media store for the one or more media files. This may avoid delays in the playback of the one or more media files, which may otherwise occur due to searching for the one or more media files.

The input from the user may include a selection of a media item identified in the user database and, in response to the selection, the remote server may be configured to transmit an instruction to the playback unit to play a media file stored in the local media store, the media file containing the selected media item. In this manner, by making a selection via the user interface, the user may control which media file is played by the playback unit.

For example, if the user selects an audio track via the user interface, then the remote server may transmit an instruction to the playback unit to play the audio file containing the selected audio track.

In some embodiments, in response to the input from the user, the remote server may be configured to generate a playlist including a set of media items identified in the user database, and to transmit an instruction to the playback unit to play a set of media files stored in the local media store, the set of media files containing the set of media items in the playlist.

In this manner, a playlist that is generated at the remote server may be played by the playback unit by playing media files stored in the local media store.

The playlist may be generated based on the input from the user. For example, the user may select, via the user interface, one or more categories such as genre, mood, era, or other category. Then, the remote server may generate a playlist from the media items in the user database, based on the one or more categories selected by the user. This may avoid the user having to manually select media files in the local media store for playback.

Alternatively, the remote server and/or a user device that presents the user interface may be configured to automatically generate one or more playlists including a set of media items identified in the user database, for example based on a predetermined set of criteria, for example frequency of playing, popularity, genre, etc.

In this case, a user may be able to select one of the automatically generated playlists using the user interface. In this manner, the user can quickly and easily choose a playlist with minimal input or effort.

In some embodiments, the media database may include identification information of media items, each of which has a set of reference information associated therewith. The set of reference information for a media item may include information relating to that media item, for example information that characterises or categorises that media item, such as genre, mood, era, popularity, etc.

The reference information may be different from the metadata that is extracted for the media files which may, for example, include track name, artist name, album name. In this manner, the remote server may have access to information relating to each of the media items in the media database and, therefore, to the media items identified in the user database. Accordingly, the remote server may take into account the reference information for the media items, e.g. when generating playlists or recommending content to the user. This may enable the user interface to present accurate and up-to-date information to the user about media files stored in the local media store.

The remote server may be configured to categorise the media items identified in the user database based at least in part on reference information associated with corresponding media items in the media database. This may involve analysing, by the remote server, reference information associated with media items identified in the user database to determine what categories are present in the user database, and then organising the user database according to the determined categories.

A “category” of media items may refer to a group of media items which share a common characteristic, e.g. genre, era, mood, tempo, popularity, etc. In this manner, information that is available to the remote server may be used to categorise media items corresponding to the plurality of media files stored in the local media store. This also avoids having to organise the media files on the local media store itself, which may be a time-consuming process.

For example, the remote server may be configured to categorise the media items in the user database by one or more of genre, era, mood, popularity, etc. This may enable the user to more easily locate a media item of a desired type. This may also enable the remote server to determine user preferences, e.g. based on one or more categories that are present in the user database, which may improve the remote server's ability to recommend content and/or generate playlists for the user.

The remote server may be configured to categorise the media items identified in the user database, based at least in part on a user profile stored in the remote server. In this manner, the remote server may take into account information stored in the user's profile when categorising media items in the user database.

The user profile may include information such as user preferences (e.g. preferred genres, eras, etc.), playback history, location, user demographic.

As an example, the remote server may categorise media items in the user database in terms of the frequency with which the user has played the media items.

As another example, the remote server may determine, based on information stored in the user profile, preferred media items for particular times of day.

This may improve the remote server's ability to recommend content and/or generate playlists for the user, as well as enable the user to easily find a desired media item. The user profile may be associated with a user of the content playback system. The user profile may be updated as the user uses the content playback system.

The user interface may be configured to present a categorised version of the user database to a user. For example, the remote server may determine (e.g. based on the reference information and/or user profile) a set of categories corresponding to the media items in the user database. Then, presenting a categorised version of the user database to the user may involve presenting the media items in the user database organised according to the determined set of categories.

In some cases, presenting a categorised version of the user database to the user may involve presenting the set of determined categories to the user. This may enable the user to browse and/or search the user database according to the determined set of categories, which may facilitate finding a desired media item. This may also allow the user to have an overview of categories corresponding to the media files stored in the local media store.

The metadata extraction unit may be configured to extract metadata for each of the media files stored in the local media store and transmit the extracted metadata to the remote server at regular time intervals. In this manner, the remote server may regularly receive extracted metadata for the plurality of files stored in the local media store. This may enable the remote server to keep the user database up-to-date, e.g. so that deletions of media files and additions of new media files in the local media store are reflected in the user database.

As an example, the metadata extraction unit may be configured to extract metadata for each of the media files stored in the local media store and transmit the extracted metadata to the remote server once a day, e.g. at a pre-determined time. The remote server may be configured to update the user database each time extracted metadata is received by the remote server, so that the user database is kept up-to-date.

In some embodiments, the metadata extraction unit may be configured to extract metadata for each of the media files stored in the local media store and transmit the extracted metadata to the remote server when a change in the plurality of media files stored in the local media store is detected. A change in the plurality of media files stored in the local media store may, for example, correspond to a change in number of media files stored in the local media store. This may occur through deletion of a media file from the local media store, and/or through addition of a new media file to the local media store or removal of a storage device entirely. In this manner, each time a change is made to the plurality of media files in the local media store, metadata is extracted and transmitted to the remote server. This may enable the remote server to keep the user database up-to-date, i.e. to ensure that media items identified in the user database corresponds to the plurality of media items stored in the local media store.

The metadata extraction unit may be configured to regularly monitor the number of media files stored in the local media store, to enable detection of a change in the plurality of media files stored in the local media store. The remote server may be configured to update the user database each time extracted metadata is received by the remote server, so that the user database is kept up-to-date.

The metadata extraction unit may be configured to maintain a record of media files for which metadata has been extracted. This may enable the metadata extraction unit to avoid extracting metadata for the same media file multiple times. Thus, when extracting metadata for the plurality of media files stored in the local media store, the metadata extraction unit may be configured to extract metadata only for media files for which metadata has not been previously extracted. This may avoid duplication of work by the metadata extraction unit, as the metadata extraction unit need only extract metadata for media files for which metadata has not already been extracted. The metadata extraction unit may include a memory for storing the record of media files for which metadata has been extracted.

The user interface may include a graphical user interface. In this manner, the user database may be presented graphically (visually) to the user. This may facilitate interaction of the user with the user database, such as browsing and searching of the user database.

The graphical user interface may be configured for display on a screen or display, for example on a user device such as a smartphone, tablet computer, laptop computer, personal computer or similar.

In some cases, the playback unit may include a display which is configured to display the graphical user interface.

For example, the graphical interface may be configured to display a list of media items identified in the user database.

The graphical user interface may be presented using an application (App) or software running on the user device or the playback unit.

The graphical user interface may be configured to enable the user to do one or more of browse, search and select media items and/or playlists from the user database. The device (e.g. user device or playback unit) on which the graphical user interface is presented may include an input mechanism for receiving an input from the user, such as a touchscreen, keypad or mouse.

The user interface may include a voice user interface, such that a user may interact with the user interface via voice commands. Thus, the user may interact with the voice user interface by issuing voice commands. For example, the user may search for and select media items in the user database by issuing voice commands. This may enable hands-free interaction with the user database. This may also enable interaction with the user database where the content playback system does not include any screen for displaying a graphical user interface.

The voice user interface may be configured to enable the user to do one or more of browse, search and select media items and/or playlists from the user database via voice commands.

The voice user interface may be implemented by a device having a microphone for detecting voice commands and suitable software installed thereon. For example, the device may be a user device such as a smartphone, tablet computer, laptop computer or similar, or a smart speaker (e.g. where the playback unit is a smart speaker).

In some embodiments, the user interface may include both a graphical user interface and a voice user interface.

The local media store may include an external storage device that is connected to the playback unit. For example, the external storage device may be a USB drive or an external drive (e.g. hard disk drive or solid state drive).

The external storage device may be connected to the playback unit via a wired connection (e.g. USB, Firewire, Ethernet), in which case the playback unit may include a connection port for connecting the external storage device.

The external storage device may be connected to the playback unit via a wireless connection (e.g. Bluetooth).

Where the local media store includes an external storage device that is connected to the playback unit, the metadata extraction unit may be implemented by software that is installed on the playback unit.

The local media store may include a network-attached storage that is communicatively coupled to the playback unit and the metadata extraction unit over a local network. This may be beneficial where there are multiple playback units connected to the local network, as each playback unit may access media files stored in the local media store over the local network. The metadata extraction unit may also be connected to the local media store over the local network.

The playback unit may comprise a smart speaker. In this manner, the user may control the playback unit via voice commands. The smart speaker may include a controller for interpreting voice commands received from the user. In some cases, the voice commands from the user may be transmitted from the playback unit to the remote server for interpretation. The remote server may then transmit instructions to the playback unit, based on the user's voice command. This may include instructions to the playback unit to play one or more media files stored in the local media store. In some cases, depending on of voice command, these media files may correspond to a playlist that is generated at the remote server.

As discussed above, the playback unit may also be configured to present the user interface in the form of a voice user interface, so the user may interact with the voice user interface by making voice commands to the smart speaker.

In general, the term “smart speaker” may mean any (local or wide area) network connected speaker that accepts voice commands.

Smart speakers may typically not have any graphical user interface, as they often do not have any screen. Thus, it may be beneficial for the user interface generated by the content playback system to include a graphical user interface that is accessed by a user device separate from the smart speaker, as this may facilitate interacting with the user database. For example, where the playback unit includes a smart speaker, the content playback system may be configured to generate a graphical user interface that is presented on a user device (e.g. smartphone, tablet computer, laptop computer, personal computer, or similar).

In some embodiments, the playback unit may comprise an in-vehicle entertainment system. An in-vehicle entertainment system may only have limited functionality and user interfaces. Accordingly, it may be difficult for the user to find desired content when using an in-vehicle entertainment system. Thus, the user interface generated by the system of the invention may serve to facilitate browsing and searching content on the local media store when using an in-vehicle entertainment system, as the user can use the generated user interface rather than any interfaces provided by the in-vehicle entertainment system. An in-vehicle entertainment system may, for example, include an in-vehicle audio system.

Where the playback unit comprises an in-vehicle entertainment system, the local media store may be a portable storage device, for example a USB connected storage device such as a USB stick, that can be connected to the in-vehicle entertainment system or storage within an in-vehicle entertainment system.

According to a second aspect of the invention, there is provided a method of controlling a content playback system, the method comprising: extracting metadata for each of a plurality of media files stored in a local media store; receiving, at a remote server, the extracted metadata; generating, based on the extracted metadata and a media database available to the remote server, a user database including identification information of media items contained in the plurality of media files stored in the local media store; and providing a user interface for interacting with the user database.

The method of the second aspect of the invention may be performed with the content playback system of the first aspect of the invention.

Features of the first aspect of the invention may be shared with the second aspect of the invention, and are not described again.

The user database may associate each media item identified in the user database with a corresponding media file stored in the local media store that contains that media item.

The metadata extracted for each media file in the local media store may include an indication of a storage location in the local media store of that media file; and generating the user database may include associating each media item identified in the user database with an indication of a storage location in the local media store of a corresponding media file stored in the local media store that contains that media item.

The user interface may be configured to receive an input from a user, and the method may further include: receiving an input from the user via the user interface; in response to the input from the user, transmitting by the remote server, an instruction to a playback unit to play one or more media files stored in the local media store, the playback unit being configured to play media files stored in the local media store; and controlling the playback unit to play the one or more media files stored in the local media store.

The instruction to the playback unit may include an indication of the storage location on the local media store for the one or more media files to be played.

The input from the user may include a selection of a media items identified in the user database, and the instruction to the playback unit may be an instruction to play a media file stored in the local media store, the media file containing the selected media item.

The method may further comprise: in response to the input from the user, generating by the remote server a playlist including a set of media items identified in the user database; and transmitting by the remote server an instruction to the playback unit to play a set of media files stored in the local media store, the set of media files containing the set of media items in the playlist.

The media database may include identification information of media items, each of which has a set of reference information associated therewith.

The method may further comprise categorising, by the remote server, the media items identified in the user database based at least in part on reference information associated with corresponding media items identified in the media database.

The method may further comprise categorising, by the remote server, the media items identified in the user database, based at least in part on a user profile stored in the remote server.

The user interface may be configured to present a categorised version of the user database to a user.

The method may comprise extracting metadata for each of the media files stored in the local media store and transmitting the extracted metadata to the remote server at regular time intervals.

The method may comprise extracting metadata for each of the media files stored in the local media store and transmitting the extracted metadata to the remote server when a change in the plurality of media files stored in the local media store is detected.

The method may further comprise maintaining a record of media files for which metadata has been extracted.

### BRIEF DESCRIPTION OF THE DRAWINGS

Embodiments of the invention are discussed below with reference to the accompanying drawings, in which:

FIG. 1 is a schematic diagram illustrating a content playback system according to an embodiment of the invention;

FIG. 2 is a schematic diagram illustrating a content playback system according to an embodiment of the invention;

FIG. 3 is a diagram illustrating a method according to an embodiment of the invention;

FIG. 4 is a table illustrating extracted metadata that may be obtained using a content playback system or method according to an embodiment of the invention;

FIG. 5 is a table illustrating a media database that may be used with a content playback system or method according to an embodiment of the invention; and

FIG. 6 is a table illustrating a user database that may be obtained using a content playback system or method according to an embodiment of the invention.

### DETAILED DESCRIPTION; FURTHER OPTIONS AND PREFERENCES

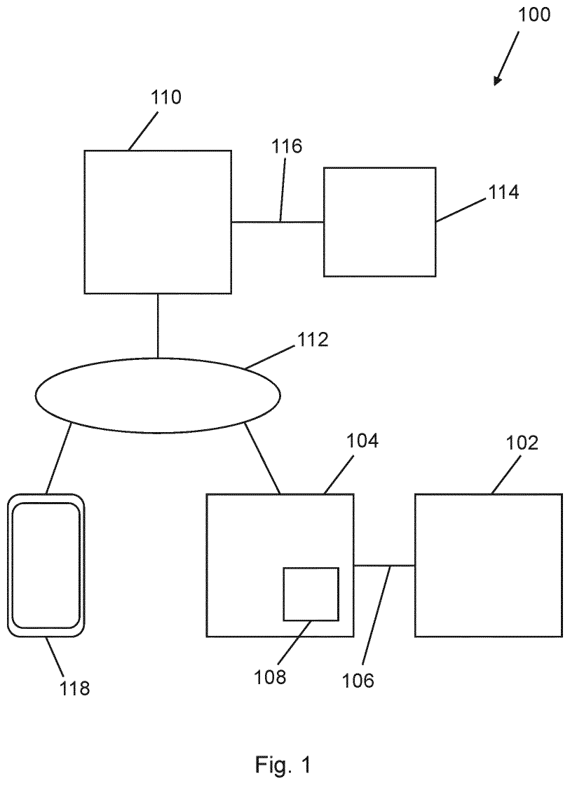

FIG. 1 is a schematic diagram of a content playback system 100 according to an embodiment of the invention.

The content playback system 100 includes a local media store in the form of a network-attached storage (NAS) 102. A plurality of media files are stored in the NAS 102. In the example described, the media files are audio files; however, other types of media files may be used in other embodiments of the invention.

The audio files may be MP3, AAC, WMA or some other type of audio file. In some cases, the audio files may be high-resolution audio files such as FLAC or WAV.

The content playback system 100 further includes a playback unit 104. The playback unit 104 is a network-enabled device that is communicatively coupled to the NAS 102 over a local network 106. For example, the playback unit 104 and NAS 102 may be in communication over a wireless local network (e.g. WiFi network).

The playback unit 104 is configured to play audio files stored in the NAS. Thus, the playback unit 104 includes a controller configured to access the audio files stored in the NAS 102 and play the audio files via one or more speakers of the playback unit 104.

In some embodiments, the playback unit 104 may be in the form of a smart speaker. In other embodiments, the playback unit 104 may be in the form of a computing device which is connected to one or more speakers. For example, the playback unit 104 may be in the form of a home audio system or an in-vehicle entertainment system.

Each audio file stored in the NAS 102 contains a media item in the form of an audio track that is playable by the playback unit 104, and a set of metadata identifying the audio track. For example, the set of metadata contained in an audio file may include identification information such as track name, artist name, track number, album name, or other information about the audio track.

The playback unit 104 includes a metadata extraction unit 108, for extracting metadata from the audio files stored in the NAS 102. The metadata extraction unit 108 may be implemented by software that is installed on the playback unit 104, such that the controller of the playback unit 104 is configured to perform the operations discussed below in relation to the metadata extraction unit 108. The metadata extraction unit 108 is configured to access the audio files stored in the NAS 102 (via local network 106), and extract a set of metadata for each of the audio files. A set of metadata may be extracted for each of the audio files on the NAS 102 by reading the audio file to extract the metadata contained therein. Thus, extracted metadata for each of the audio files stored in the NAS 102 may include information such as track name, artist name, track number, album name.

In other embodiments, the metadata extraction unit may instead be included in the NAS 102, or provided separately and communicatively connected to the playback unit 104 and/or NAS 102.

The content playback system 100 further includes a remote server 110 (e.g. a cloud server) which is communicatively coupled to the playback unit 104 via the internet 112. The remote server 110 may be any suitable computer server that is connected to the internet, and has software installed thereon for performing the operations described below.

The remote server 110 is configured to receive data from, and transmit data to, the playback unit 104 (including the metadata extraction unit 108). In particular, the remote server 110 is configured to control playback of audio files stored in the NAS 102 by the playback unit 104. To do this, the remote server 110 may be configured to transmit instructions to the playback unit 104 for controlling playback of audio files. An instruction from the remote server 110 to the playback unit 104 may include an indication of one or more audio files stored in the NAS 102 that are to be played by the playback unit 104. In response to receiving an instruction from the remote server 110, the controller in the playback unit 104 may be configured to play the one or more audio files indicated in the instruction.

The remote server 110 is connected to a database server 114. In the embodiment shown, the remote server 110 is connected to the database server 114 via a local network 116; however, in other embodiments, the remote server may be connected to the database server 114 via the internet 112. The database server 114 stores a media database, which includes identification information of audio tracks. For example, where the remote server 110 and the database server 114 are part of an online music service, the media database may include identification information for all of the audio tracks that are known to the online music service.

In other embodiments, the remote server 110 and database server 114 may be included in the same device or apparatus, for example they may both be provided by the same physical or virtual server.

After extracting the metadata for each of the audio files stored in the NAS 102, the metadata extraction unit 108 is configured to transmit the extracted metadata to the remote server 110 over the internet 112. Upon receiving the extracted metadata from the metadata extraction unit 108, the remote server 110 is configured to generate a user database comprising identification information of audio tracks contained in the plurality of audio files stored in the NAS 102.

The remote server 110 is configured to generate the user database by comparing the extracted metadata to the media database stored in the database server 114, in order to identify audio tracks from the media database that are contained in the plurality of audio files stored in the NAS 102.

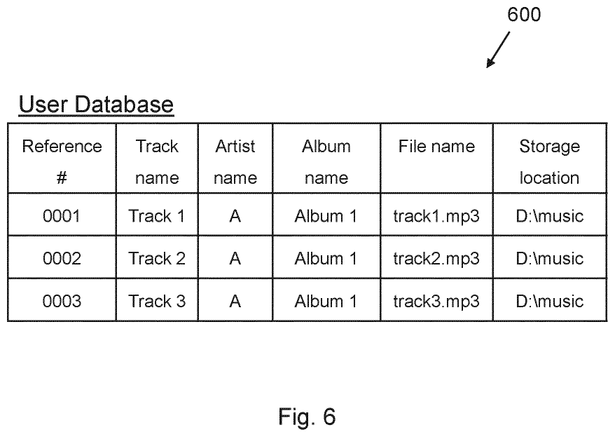

This may be achieved, for example, by searching the media database for audio tracks that match the extracted metadata (e.g. based on one or more of track name, artist name, and album name). The process for generating the user database is described in more detail below, with reference to FIGS. 5 and 6.

Following generation of the user database, the remote server 110 is configured to generate a user interface to enable a user to interact with the user database. The user interface is a graphical user interface which is configured to be presented to the user on a mobile device 118 (e.g. smartphone, tablet computer, or other computing device). For example, the graphical user interface may be presented via a web browser or application on the mobile device 118. The mobile device 118 may be communicatively coupled to the remote server 110 via the internet 112, to that the remote server 110 can transmit the user interface to the mobile device 118 for display.

In other embodiments, the user interface may be generated directly at the mobile device 118. In such an embodiment, the remote server 110 may be configured to transmit the user database to the mobile device 118, which is itself configured to generate a user interface for interacting with the user database.

In other embodiments, the user interface may be presented to the user on the playback unit 104 instead of on a separate mobile device 118, where the playback unit 104 has a display for displaying the user interface. In that case, the mobile device 118 may be omitted from the content playback system.

The user interface may be configured to enable the user to browse and search the user database. The user interface may also be configured to receive inputs from the user. For example, the user interface may enable the user to select one or more audio tracks and/or playlists from the user database, and/or to indicate user preferences.

Inputs from the user may be received from the user via an input mechanism on the mobile device 118 (or on the playback unit 104 where the user interface is instead presented by the playback unit 104), such as a touchscreen or keypad.

The mobile device 118 and/or the playback unit 104 may also be configured to receive inputs from the user in the form of voice commands, e.g. detected via a microphone on the mobile device 118. The mobile device 118 and/or playback unit 104 may have speech recognition software installed thereon for interpreting voice commands from the user.

Following an input received from the user via the user interface presented on the mobile device 118 or the playback unit 104, the mobile device 118 or the playback unit 104 may transmit an indication of the user's input to the remote server 110 via the internet 112. The remote server 110 may then transmit an instruction to the playback unit 104 based on the user's input. For example, where the user's input includes a selection of an audio track in the user database, the instruction from the remote server 110 may be an instruction to play an audio file stored in the NAS 102, the audio file corresponding to the selected audio track.

In this manner, the user interface may enable a user to interact with the user database (which corresponds to the audio files stored in the NAS 102), as well as control playback of media files stored on the NAS 102 by the playback unit 104.

Components of the content playback system 100 may be modified according to various requirements. For example, a different type of storage may be used instead of NAS 102 for locally storing a plurality of audio files, such as an external storage device directly connected to the playback unit 104. In some cases, the metadata extraction unit 108 may be implemented separately from the playback unit 104, e.g. as part of the mobile device 118 or as a stand-alone device. In some cases, the user interface may be presented by the playback unit 104 itself, rather than by mobile device 118.

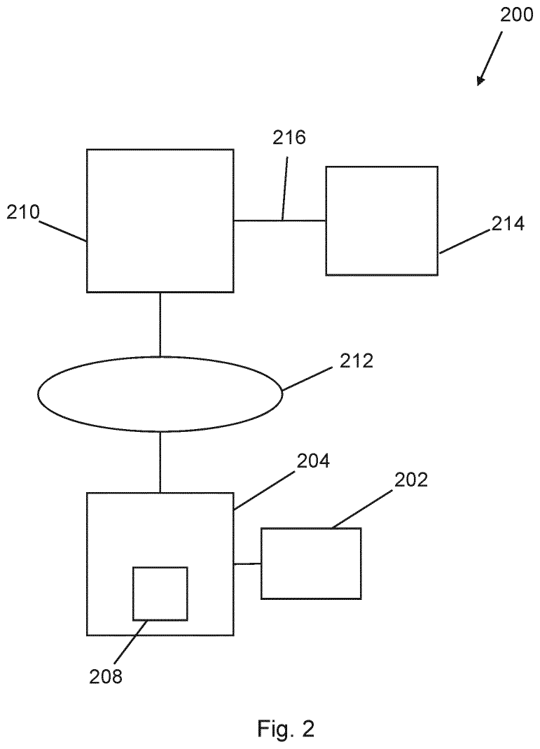

FIG. 2 is a schematic diagram of a content playback system 200 that is another embodiment of the invention. The content playback system 200 includes a local media store in the form of an external storage device 202 having a plurality of audio files stored therein. The external storage device 202 may, for example, be a USB drive or an external drive. The audio files may be similar to those described above in relation to content playback system 100.

The content playback system 200 further includes a playback unit 204. The external storage device 202 is directly connected to the playback unit 204, such that the external storage device 202 may act as external storage for the playback unit 204. For example, the external storage device 202 may be plugged into a connection port on the playback unit (e.g. USB port). In some cases, the external storage device 202 may be wirelessly connected to the playback unit 204, e.g. via a Bluetooth connection. In other embodiments, a local media store may be directly incorporated into the playback unit 204, e.g. the playback unit 204 may include an internal memory configured to store a plurality of audio files.

The playback unit 204 is similar to the playback unit 104 described above, as it includes a controller and one or more speakers for playing audio files stored in the external storage device 202. The playback unit 204 may be in the form of a computing device which is connected to one or more speakers. For example, the playback unit 204 may be in the form of an in-vehicle entertainment system.

The playback unit 204 also includes a metadata extraction unit 208 for extracting metadata from the audio files stored in the external storage device 202. The metadata extraction unit 208 may be implemented by software that is installed on the playback unit 204, such that the controller of the playback unit 204 is configured to perform the operations discussed in relation to the metadata extraction unit 208. The metadata extraction unit 208 may function in a similar manner to extraction unit 108 described above, to extract metadata from the media files stored in the external storage 202.

The playback unit 204 is communicatively coupled to a remote server 210 via the internet 212. The remote server 210 is connected to a database server 214 via a local network 216. The remote server 210 and database server 214 are configured in a similar manner to the remote server 110 and database server 114 described above. Following extraction of the metadata from the audio files stored in the external storage device 202, the metadata extraction unit 208 is configured to transmit the extracted metadata to the remote server 210 over the internet. The remote server 210 is then configured to generate a user database, based on the extracted metadata and a media database stored in the database server 214, in a similar manner to that described above in relation to system 100.

After generating the user database, the remote server 210 is configured to generate a user interface for interacting with the user database. In this embodiment, the user interface is configured for presentation directly on the playback unit 204, rather than on a separate mobile device. The remote server 210 is configured to transmit the user interface to the playback unit 204 via the internet, for presentation on the playback unit 204. In other examples, the playback unit 204 may be configured to generate the user interface itself. In such examples, the remote server 210 may be configured to transmit the user database to the playback unit 204, so that the playback unit 204 may generate the user interface based on the user database.

However, in other embodiments the user interface may instead be presented on a separate user device (e.g. a mobile device) that is in communication with the remote server 210.

The user interface may include a graphical user interface, in which case the playback unit 204 may include a screen (display) which is configured to display the graphical user interface. The playback unit 204 may further include an input mechanism which is configured to receive inputs from the user to enable the user to interact with the graphical user interface, e.g. the screen may be a touchscreen, and/or the playback unit 204 may include a keypad or one or more buttons. Additionally or alternatively, the playback unit 204 may be configured to receive inputs from the user in the form of voice commands from the user, so that the user may interact with the graphical user interface via voice commands. For example, the playback unit 204 may include a microphone for detecting voice commands, and voice recognition software for interpreting the voice commands. In some cases, the voice commands may be transmitted by the playback unit 204 to the remote server 210 for interpretation.

In some embodiments, the user interface may include a voice user interface, which is configured to enable the user to interact with the user database via voice commands. For example, the user interface may be configured to provide audio responses (e.g. via the one or more speakers in the playback unit 204) to voice commands from the user. This may, for example, enable the user to browse, search, and select audio tracks from the user database. Such a voice user interface may be beneficial where the playback unit 204 is in the form of a smart speaker or similar device which does not have any screen, such that the playback unit 204 is not capable of displaying a graphical user interface.

In some embodiments, the graphical user interface may present one or more automatically generated playlists of the audio tracks in the user database, such that a user can select one of the automatically generated playlists to be played by the playback unit 104. For example, the playlists may be automatically generated by the remote server 210 based on predetermined criteria, such as a genre, frequency of play, popularity, etc.

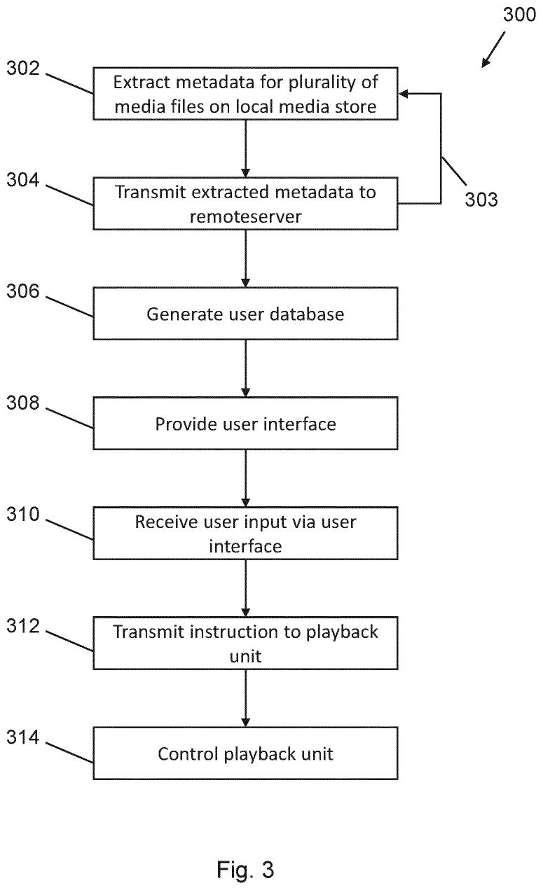

FIG. 3 is a schematic diagram illustrating a method 300 according to an embodiment of the invention. The method 300 may be performed using a content playback system according to an embodiment of the invention, such as content playback system 100 or content playback system 200.

At step 302, metadata is extracted for each of a plurality of media files stored in a local media store. This may be performed by a metadata extraction unit (e.g. 108 or 208). In order to initiate extraction of metadata, a user may first need to provide an indication of a location of the local media store to the content playback system. For example, in the case of content playback system 100, this may involve the user inputting a network address of the NAS 102 (e.g. via an application on mobile device 118), or selecting the NAS 102 from a list of available storage devices. The extraction of metadata may then be performed by metadata extraction unit 108, which reads each of the plurality of audio files stored in the NAS 102, to extract the metadata contained in each audio file.

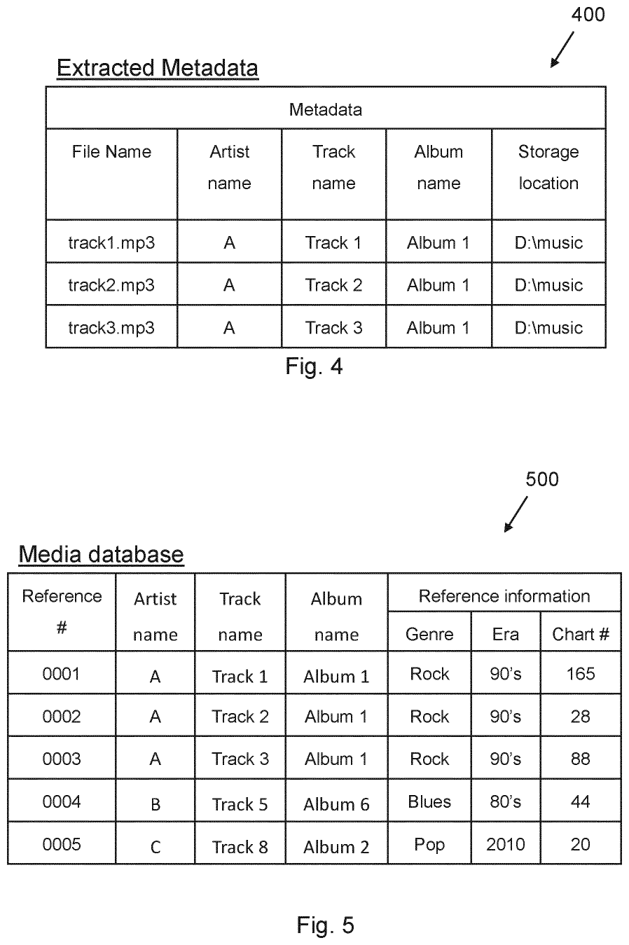

FIG. 4 shows an example of metadata 400 extracted by a metadata extraction unit (e.g. metadata extraction 108 or 208) for a plurality of audio files stored in the local media store (e.g. NAS 102), where the plurality of audio files includes three audio files, track1.mp3, track2.mp3 and track3.mp3. In the example of FIG. 4, the media files stored in the local media store are in the form of MP3 audio files; however, in other examples, different types of media files may be used. As can be seen, for each of the plurality of audio files, the extracted metadata includes an indication of the name of the audio file (e.g. “track1.mp3”), an indication of the artist name (e.g. “A”), an indication of the track name (e.g. “Track 1”), an indication of the album name (e.g. “Album 1”), and an indication of a storage location of the audio file on the local media store (e.g. “D:\music”). The artist name, track name and album name may correspond to metadata that is contained in the audio file itself, and which may be extracted by reading the audio file. Similarly, the file name and storage location may be obtained by the metadata extraction unit when reading the audio file.

In the example shown, the storage location indicates an address of a folder (“music”) on the local media store in which the plurality of audio files is stored. The storage location may further indicate an address of the local media store itself, e.g. a network address such as an IP address (e.g. where a NAS is used).

Following the extraction of metadata for the plurality of media files on the local media store, the extracted metadata is transmitted to a remote server, as indicated by step 304. In the example of content playback system 100, the metadata extraction unit 108 may transmit the extracted metadata to the remote server 110 over the internet 112. The extracted metadata may be transmitted to the remote server in a format similar to that shown in FIG. 4.

Steps 302 and 304 may be repeated multiple times, as indicated by arrow 303 in FIG. 3. In one embodiment, steps 302 and 304 may be repeated at regular time intervals, e.g. at a pre-determined time each day. In this manner, metadata may be regularly extracted for the plurality of media files stored in the local media store, and transmitted to the remote server. In another embodiment, 302 and 304 may be performed each time a change is detected in the plurality of media files stored in the local media store, e.g. when deletion of a media file from, or addition of a new media file to, the local media store occurs. As a result of repeating steps 302 and 304 in one of these ways, it may be possible to ensure that the user database generated by the remote server is maintained up-to-date, to accurately reflect changes in the plurality of media files on the local media store.

The metadata extraction unit may be configured to maintain a record of the media files on the local media store, for which metadata has already been extracted. For example, the metadata extraction unit may keep a list of media file names of the media files for which is has already extracted metadata. In this manner, when step 302 is repeated, it is possible to extract metadata only for newly added media files, i.e. media files for which metadata has not been previously extracted. This may avoid duplication of work by the metadata extraction unit, and increase the speed of step 302 for subsequent iterations, i.e. after an initial extraction of metadata for all of the media files on the local media store.

The metadata extraction unit may include an internal memory in which the extracted metadata is stored. Each time step 302 is performed, the extracted metadata in the internal memory of the metadata extraction unit is updated. Then, in step 304, the updated extracted metadata is transmitted to the remote server.

After receipt of the extracted metadata by the remote server, the method 300 involves generating, by the remote server, a user database in step 306. The user database is generated based on the extracted metadata (e.g. as shown in FIG. 4), and a media database that is accessible by the remote server. In the example of content playback system 100, the media database is stored in database server 114. The user database generated by the remote server includes identification information of media items contained in the plurality of media files stored in the local media store. For example, the user database may be in the form of a list of media items corresponding to the plurality of media files stored in the local media store.

FIG. 5 shows an example of a portion of a media database 500 that may be stored in a database server and which is used to generate the user database. The media database 500 includes identification information for a set of media items in the form of audio tracks, including information such as artist name, track name and album name for each of the audio tracks. The media database 500 includes a reference number for each audio track, to facilitate identification of each audio track. The media database 500 further includes a set of reference information for each audio track in the media database, the set of reference information including an indication of categories such as genre, era, and mood for the audio track. In other examples, the set of reference information may include further or different types of information relating to the audio tracks. In some cases, the reference information may also include images (e.g. album artwork) and/or videos (e.g. music videos) associated with the audio tracks.

In the example shown, the reference information is included directly in the media database 500. However, in other examples, the reference information need not necessarily be included in the media database itself, and may be stored separately. In such an example, reference information may be associated with an audio track in the media database, e.g. by reference to the reference number of the audio track or other suitable means for associating reference information to an audio track in the media database.

The media database 500 may comprise an exhaustive list of audio tracks that are known to the database server. In practice, the list of audio tracks in the media database 500 may be much longer than that shown in FIG. 5; for illustration purposes however, only a short portion of the media database 500 is shown in FIG. 5. The media database 500 is one possible example of a layout of a media database; in practice many different formats may be used for the media database.

Returning to step 306 of FIG. 3, the remote server generates the user database by identifying media items in the media database which are contained in media files stored in the local media store, based on the received extracted metadata. This may involve, for each media file stored in the local media store, searching the media database for a media item corresponding to the media file, based on the extracted metadata for that media file.

Referring to the example of FIGS. 4 and 5, the remote server may search the identification information of the audio tracks in the media database 500 based on the extracted metadata 400, in order to identify audio tracks that are contained in the media files stored on the local media store. More specifically, for each audio file stored in the local media store, the remote server searches the media database 500 for an audio track based on the metadata extracted for that audio file (e.g. artist name, track name, duration and album name). If the remote server finds an audio track in the media database 500 that closely matches the extracted metadata, then that audio track is added to the user database. In the example of FIGS. 4 and 5, audio tracks having reference numbers 0001, 0002 and 0003 in the media database 500 correspond to the extracted metadata shown in FIG. 4 for the audio files stored in the local media store, as can be seen by the matching artist, track and album names. Therefore, audio tracks having reference numbers 0001, 0002 and 0003 will be identified in the search, and added to the user database.

The search performed on the media database by the remote server may involve string matching techniques, for matching extracted metadata (e.g. artist name, track name, album name) with audio track information in the media database. In some cases, approximate string matching techniques (e.g. “fuzzy searching”) may be used, to account for cases where the extracted metadata does not exactly match information in the media database (e.g. due to variations in punctuation, capitalisation, character spacing, etc.).

FIG. 6 shows an example of a user database 600 that may be generated by the remote server, based on the extracted metadata 400 and the media database 500. The user database 600 includes identification information of audio tracks that were identified by searching the media database 500 based on the extracted metadata 400. As can be seen, the user database 600 includes an indication of track name, artist name and album name for each of the identified audio tracks. The user database 600 also includes, for each identified audio track, an indication of the file name of the corresponding audio file on the local media store. Furthermore, the user database 600 associates each audio track in the user database 600 with an indication of the storage location for the audio file on the local media store that contains that audio track. The storage location is obtained directly from the extracted metadata 400. In some examples, the user database may include all metadata extracted by the metadata extraction unit.

The user database 600 also associates each audio track in the user database 600 with a reference number corresponding to the reference numbers used in the media database 500. This may enable the remote server to easily identify reference information for the audio tracks in the user database 600 based on the reference information in the media database 500.

Accordingly, the user database 600 includes a list of audio tracks that corresponds to the plurality of audio files stored in the local media store. The remote server may be configured to update the user database each time extracted metadata is received by the remote server, e.g. each time loop 303 is repeated.

In some examples, the user database 600 may include further information which is not shown in FIG. 6. For example, the user database 600 may include a user identifier. The user identifier may be associated with a user profile stored on the remote server, and so may serve to associate the user database 600 with a particular user profile stored on the remote server. The user database 600 may include a database identifier, which may serve to identify the user database 600. The user database 600 may include data about the storage device, e.g. name of storage device, type of storage device, size of storage device, location of storage device, etc. The user database 600 may also include any reference information included in the media database 500, e.g. the reference information from the media database 500 may be copied into the user database 600. This may facilitate looking up reference information for each of the audio tracks in the user database 600. Thus, for example, the user database 600 may include information such as genre, mood, era and/or popularity data, and any other information that may be useful for generating user playlists and/or categorising the audio tracks in ways that aid contextual presentation.

In some cases, it may be possible that there is no media item in the media database corresponding to a media file stored in the local media store. In such a case, no media item may be identified as corresponding to that media file when searching the media database based on the metadata extracted for that media file. In such a case, the extracted metadata for that media file may be added directly to the user database, but without any identification information or reference metadata from the media database (as there is none in the media database corresponding to that media file). This allows the media file to still be used and browsed, by using the extracted metadata for that media file. Thus, the media file may still be used in playlists, and/or searched and played via a user interface.

As part of generation of the user database, the remote server may be configured to categorise media items in the user database based on reference information that is associated with corresponding media items in the media database. In this manner, the remote server may determine which categories are present amongst the media items in the user database. This may in turn facilitate finding a desired type of media item, and enable the remote server to improve recommendations and/or playlist generation.

In the example of FIGS. 5 and 6, the remote server may categorise the media tracks in the user database 600, using reference information contained in the media database 500. The remote server may, for example, be configured to directly associate reference information from the media database 500 with the audio tracks in the user database, e.g. based on the reference numbers for the audio tracks. So, in the example of FIGS. 5 and 6, the remote server may identify one or more of a genre, era and mood of the audio tracks in the user database 600 based on the reference information in the media database 500. Accordingly, the remote server may categorise the audio tracks in the user database 600 according to one or more of genre, era and mood. For example, the remote server may determine that audio tracks corresponding to categories “Rock”, “90's” and “Upbeat” are present in the user database 600. The tracks in the user database may then be grouped according to the identified categories.

Additionally or alternatively, the remote server may be configured to categorise media items in the user database based on a user profile stored in the remote server. The user profile may be associated with a user, and may, for example, include an indication of user preferences (e.g. preferred artists, genres, etc.). The user profile may also include a listening history of the user, as well as other information relating to the user such as location, demographic information, etc. The remote server may use the information contained in the user profile in order to categorise the media items, e.g. according to the user's preferences and listening history. This may enable the remote server to improve its ability to recommend media items and/or generate playlists for the user.

Returning to FIG. 3, at step 308 a user interface is provided to enable a user to interact with the user database. The user interface may be configured to enable the user to browse media items and search for media items in the user database, as well as make inputs via the user interface. As an example, the user interface may be in the form of a graphical user interface which displays a browsable list of media items corresponding to the media items in the user database. The user interface may be configured to enable the user to select one or more media items in the user database, and/or request a playlist to be generated from the user database. Step 308 may be implemented in various manners. In the example of content playback system 100, the user interface may be generated by the remote server 110, the user interface being configured to be presented (e.g. displayed) on the mobile device 118. Alternatively, the remote server 110 may transmit the user database to the mobile device 118, the mobile device 118 being configured to generate and present the user interface.

Where the remote server has categorised the media items in the user database, e.g. based on reference information associated with the media database and/or on the user profile, the user interface may be configured to present a categorised version of the user database. For example, the user interface may be configured to present one or more categories which were identified by the remote server based on the reference information in the media database. Where many categories were identified, the user interface may be configured to present a selection of the most prominent categories. Where the remote server categorised the media items based on the user profile, the user interface may be configured to present recommendations to the user based on information in the user profile (e.g. most played media items, preferences based on time of day, etc.). In this manner, the user interface may be tailored based on the user profile, as well as on the media items in the user database.

In step 310, the method includes receiving an input from the user via the user interface. This may, for example, include a selection of one or more media items in the user database by the user. In another example, this may include a request by the user for a playlist to be generated. The user interface may enable the user to indicate one or more preferences for a playlist to be generated, e.g. genre, mood, etc. The user input is received by the remote server. This may involve a device on which the user interface is presented transmitting an indication of the user input to the remote server. In the example of content playback system 100, a user input may be received via the user interface presented on the mobile device 118. The mobile device 118 is then configured to transmit an indication of the user input to the remote server 110.

Then, in step 312, an instruction is transmitted from the remote server to a playback unit (e.g. playback unit 104 or 204) to control the playback unit, based on the input received from the user. The instruction includes an indication of one or more media files stored in the local media store that are to be played by the playback unit. For example, the instruction may include the file names of the one or more media files to be played. The instruction may also include an indication of the storage location of the one or more media files (e.g. based on the storage location shown in user database 600). This may enable the playback unit to easily and rapidly locate the one or more media files to be played.

For example, where the input from the user includes a selection of one or more media items in the user database, the instruction may include an instruction to play one or more media files stored in the local media files corresponding to the selected one or more media items. Where the input from the user includes a playlist selection, the remote server may be configured to generate a playlist from the media items in the user database, based on the user's selection. The instruction to the playback unit may then be an instruction to play a set of media files stored in the local media store, the set of media files corresponding to media items in the generated playlist.

In step 314, the playback unit is controlled based on the instruction received from remote server. In particular, the playback unit is controlled to play the one or more media files indicated in the instruction. The playback unit may be controlled by a controller in the playback unit, which is configured to access and play the one or more media files stored in the local media store. The controller may search for the one or more media files to be played based on the file names and storage locations indicated in the instruction from the remote server. As an example, where a user selects Track 1 from the user database 600, the remote server may transmit an instruction to the playback unit including the corresponding file name (“track1.mp3”) and storage location (“D:\music”). Upon receipt of the instruction, the playback unit may then play the audio file track1.mp3 via a speaker of the playback unit.

1. A content playback system comprising:
a local media store configured to store a plurality of media files;
a playback unit configured to play media files stored in the local media store;
a metadata extraction unit configured to extract metadata for each of the plurality of media files stored in the local media store; and
a remote server configured to:
receive the extracted metadata from the metadata extraction unit; and
based on the extracted metadata and a media database available to the remote server, generate a user database including identification information of media items contained in the plurality of media files stored in the local media store;
wherein the content playback system is configured to provide a user interface for interacting with the user database.

2. The content playback system according to claim 1, wherein the user database associates each media item identified in the user database with a corresponding media file stored in the local media store that contains that media item.

3. The content playback system according to claim 1, wherein:
the metadata extracted for each media file in the local media store includes an indication of a storage location in the local media store of that media file; and
the user database associates each media item identified in the user database with an indication of a storage location in the local media store of a corresponding media file stored in the local media store that contains that media item.

4. The content playback system according to claim 1, wherein the user interface is configured to receive an input from a user and, based on the input from the user, the remote server is configured to transmit an instruction to the playback unit to play one or more media files stored in the local media store.

5. The content playback system according to claim 4, wherein the instruction to the playback unit includes an indication of a storage location in the local media store of the one or more media files to be played.

6. The content playback system according to claim 4, wherein the input from the user includes a selection of a media item identified in the user database, and, in response to the selection, the remote server is configured to transmit an instruction to the playback unit to play a media file stored in the local media store, the media file containing the selected media item.

7. The content playback system according to claim 4, wherein, in response to the input from the user, the remote server is configured to generate a playlist including a set of media items identified in the user database, and to transmit an instruction to the playback unit to play a set of media files stored in the local media store, the set of media files containing the media items in the playlist.

8. The content playback system according to claim 1, wherein the media database includes identification information of media items, each of which has a set of reference information associated therewith.

9. The content playback system according to claim 8, wherein the remote server is configured to categorize the media items identified in the user database based at least in part on reference information associated with corresponding media items identified in the media database.

10. The content playback system according to claim 1, wherein the remote server is configured to categorize the media items identified in the user database, based at least in part on a user profile stored in the remote server.

11. The content playback system according to claim 10, wherein the user interface is configured to present a categorized version of the user database to a user.

12. The content playback system according to claim 1, wherein the metadata extraction unit is configured to extract metadata for each of the media files stored in the local media store and transmit the extracted metadata to the remote server at regular time intervals.

13. The content playback system according to claim 1, wherein the metadata extraction unit is configured to extract metadata for each of the media files stored in the local media store and transmit the extracted metadata to the remote server when a change in the plurality of media files stored in the local media store is detected.

14. The content playback system according to claim 1, wherein the metadata extraction unit is configured to maintain a record of media files for which metadata has been extracted.

15. The content playback system according to claim 1, wherein the user interface includes one or more of:
a graphical user interface; and
a voice user interface, such that a user may interact with the user interface via voice commands.

16. (canceled)

17. The content playback system according to claim 1, wherein the local media store includes an external storage device that is connected to the playback unit.

18. The content playback system according to claim 1, wherein the local media store includes a network-attached storage that is communicatively coupled to the playback unit and the metadata extraction unit over a local network.

19. The content playback system according to claim 1, wherein the playback unit comprises one or more of a smart speaker and an in-vehicle entertainment system.

20. (canceled)

21. The content playback system according to claim 1, wherein the media files are audio files or video files.

22. A method of controlling a content playback system, the method comprising:
extracting metadata for each of a plurality of media files stored in a local media store;
receiving, at a remote server, the extracted metadata;
generating, based on the extracted metadata and a media database available to the remote server, a user database including identification information of media items contained in the plurality of media files stored in the local media store; and
providing a user interface for interacting with the user database.

23-25: (canceled)
